(19) United States
(12) Patent Application Publication
(10) Pub. No.: US 2014/0145424 A1
(43) Pub. Date: May 29, 2014

(54) Form for Duplex Card

(71) Applicant: INFOSEAL, LLC, Englewood, NJ (US)

(72) Inventor: David Yost, Roanoke, VA (US)

(73) Assignee: INFOSEAL, LLC, Englewood, NJ (US)

(21) Appl. No.: 14/079,734

(22) Filed: Nov. 14, 2013

Related U.S. Application Data
(60) Provisional application No. 61/729,834, filed on Nov. 26, 2012.

(51) Int. Cl. B42D 15/00

(52) U.S. Cl. CPC B42D 15/00
USPC 283/66.2

(57) ABSTRACT

A form with information card includes a document sheet with an interior border defining a first cavity, a carrier with an interior border defining a second cavity, and a planar card affixed to the carrier. The carrier is permanently affixed to the document and overlaps the document first cavity. The card resides within the first cavity such that both a top and bottom surface of the card are exposed to receive print from a printer while the card resides in the form. Related apparatus, systems, techniques, and articles are also described.

### RELATED APPLICATIONS

This application claims priority to U.S. Provisional Patent Application No. 61/729,834, filed Nov. 26, 2012, the entire contents of which are herein incorporated by reference.

### TECHNICAL FIELD

The subject matter described herein relates to forms with information cards therein, specifically, forms that enable printing on two surfaces of the information cards.

### BACKGROUND

Information cards are used to record and carry various kinds of data including advertisements, insurance records, identification data, and credit card information. These cards are often associated with documents, forms, or cover letters to explain to the user what the card is and how to use it. Forms such as those described in U.S. Pat. No. 5,439,255, enable printing on a single side of the information card. However, the popularity of these cards has created a need for a form with a removable information card that is thin, durable, and easily and conveniently printable on both top and bottom surfaces with printing equipment.

### SUMMARY

In one aspect, a form is described that includes a document with a first cavity, a carrier with a second cavity, and a card configured such that the card is affixed to the carrier and the carrier is affixed to the document. The carrier has a second cavity and is affixed to the document such that the first cavity and the second cavity overlap. The card is affixed to the carrier such that imaging (e.g., printing) can be performed directly on the back of the card. The card can reside within the first cavity, the first cavity being larger than the card. The card can be of similar thickness to the document. Optionally, the card can include weakness (e.g., perforations, partial cut in depth, etc.) and the card and carrier can be permanently affixed outside an area defined by the weakness for removal of a final card from the card. Optionally, the card and carrier can be affixed together with lift adhesives to enable easy removal of the card from the carrier.

In another aspect, a form with information card includes a planar document, a planar carrier, and a planar card. The planar document has a top and bottom surface and a continuous interior border defining a first cavity through the top and bottom surfaces. The planar carrier has a top and bottom surface, an area at least slightly larger than the first cavity, and a continuous interior border defining a second cavity through the top and bottom surfaces. The carrier is permanently affixed to the bottom surface of the document, overlaps the document first cavity, and is at least smaller than the document in dimension. The planar card has a top and bottom surface affixed to the carrier, overlaps the second cavity, resides within the first cavity, and is coplanar with the document sheet. As a result, a portion of the bottom surface of the card is exposed to receive print through the second cavity from a printer while the card resides in the form.

In yet another aspect, a form with information card includes a planar document and a planar card. The planar document has a top and bottom surface and a continuous interior border defining a first cavity through the top and bottom surfaces. The planar card has a top and bottom surface affixed to the top surface of the document, and overlapping the first cavity such that a portion of the bottom surface of the card is exposed to receive print through the first cavity from a printer while the card resides on the form.

In yet another aspect, a form with information card includes a planar document, a film layer, and a substantially continuous cut. The planar document has a top and bottom surface and one or more laminate layers permanently adhered to the document. The film layer is temporarily adhered with adhesive to one of the laminate layers and the film layer and adhesive have a cavity. The substantially continuous cut is through at least the document and one or more laminate layers thereby defining a card area. The film layer and adhesive cavity defines an area of dimension less than the area defined by the continuous cut.

One or more of the following features can be included. For example, the card can be permanently affixed to the carrier and the card can further include one or more lines of weakness defining an area. The card can be temporarily affixed to the carrier and removable via lifting. The card can further include additional material and a card cavity in the additional material. The additional material can be permanently affixed to the carrier. A final card can be temporarily affixed to the additional material such that the final card can remove from the additional material via lifting.

The card can be permanently affixed to the document and the card can further include one or more lines of weakness defining an area. The card can be temporarily affixed to the document and removable via lifting. The card can further include additional material and a card cavity in the additional material. The additional material can be permanently affixed to the document. A final card can be temporarily affixed to the additional material such that the final card can remove from the additional material via lifting.

The subject matter described herein provides many advantages. For example, and in no way limiting or affecting claim scope, the current subject matter can enable imaging on both the front and back of information cards. Additionally, the toner/print can be directly imaged on the card and not on a carrier. The image can be thus secure and intact because there is no print bearing carrier to delaminate.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram of an example embodiment of a document, an example embodiment of a carrier, and an example embodiment of a card;

FIG. 2 is a series of drawings illustrating exemplary configurations of a document, carrier, and card;

FIG. 3 is a drawing of a cross section of the fully assembled form as shown in FIG. 2;

FIG. 4 is a process flow diagram for assembly of the form as shown in FIGS. 2 and 3;

FIG. 5 is a drawing illustrating a cross section of a lift laminate form;

FIG. 6 is a drawing illustrating a lift card with additional material;

FIG. 7 is a drawing of an assembled lift form including document, carrier, and card;

FIG. 8 is a drawing illustrating a cross section view of an embodiment of a lift card with additional material that has not been kiss-cut prior to application to a carrier;

FIG. 9 is a drawing illustrating a cross section view of another example embodiment of an assembled lift form including document, carrier, and card;

FIG. 10 is a process flow diagram illustrating a method of producing a form that enables imaging on both sides of a card;

FIG. 11 is a series of drawings illustrating a form with cavity and card, the card being adhered directly over the document cavity and having lines of weakness for final card removal;

FIG. 12 is a drawing illustrating a cross section of the fully assembled form shown in FIG. 11; and

FIG. 13 is a drawing illustrating a cross section of a fully assembled form of an alternate embodiment of a form using a card as illustrated in FIG. 6.

Like reference symbols in the various drawings indicate like elements.

### DETAILED DESCRIPTION

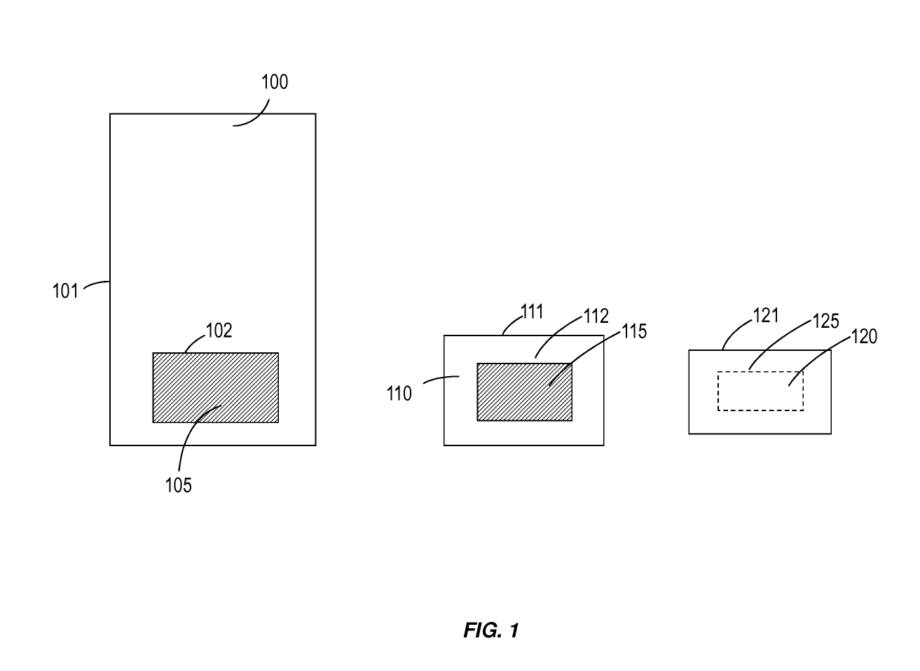

FIG. 1 is a drawing of an example embodiment of document 100, an example embodiment of carrier 110, and an example embodiment of card 120. The document 100 includes an exterior border 101 and interior border 102. The document interior border 102 is continuous and defines a first cavity 105 (e.g., hole) through the document 100. The carrier 110 is a film or sheet of paper and includes an exterior border 111 and interior border 112. The carrier exterior border 111 is continuous and defines an area at least slightly larger than the first cavity 105. The carrier interior border 112 is continuous and defines a second cavity 115 (e.g., hole) through the carrier 110. The second cavity 115, as defined by the interior border 112, has an area (or dimension) slightly smaller than the first cavity 105. The card 120 includes an exterior border 121. The card exterior border 121 defines an area (or dimension) at least slightly smaller than the first cavity 105, as defined by the document interior border 102. In this embodiment, the card 120 includes one or more lines of weakness 125 within the exterior border 121 that can define an area.

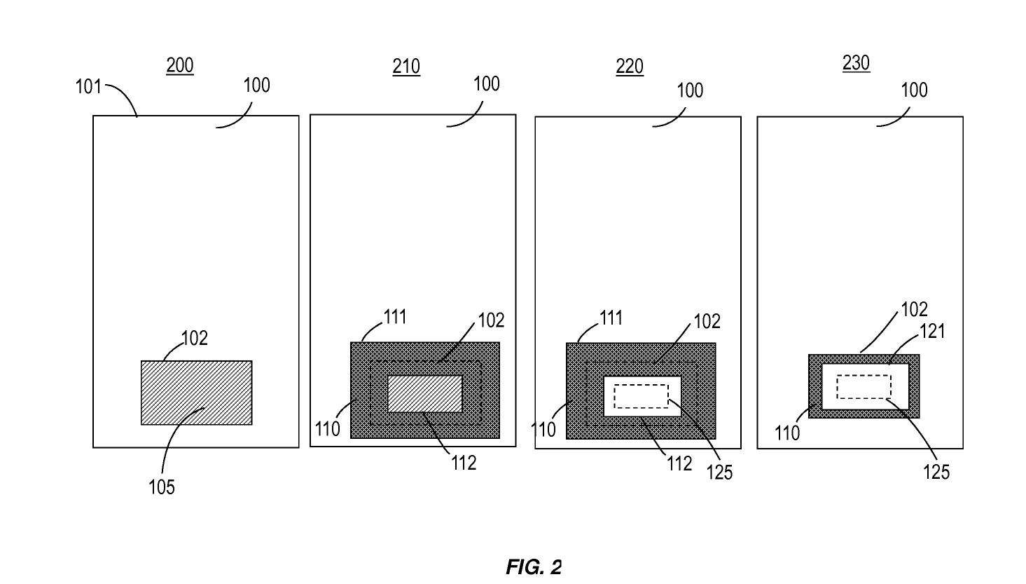

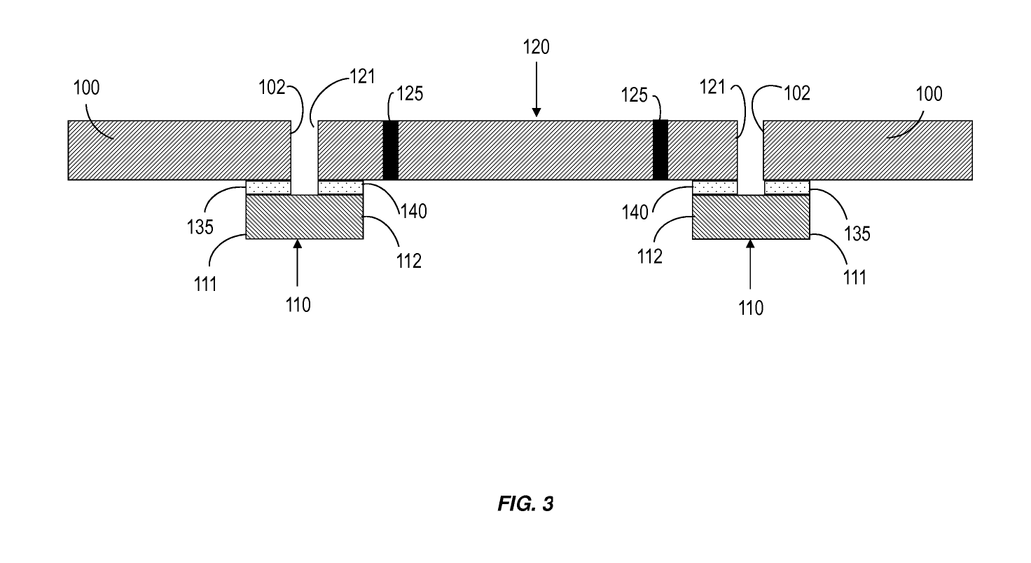

FIG. 2 is a series of drawings illustrating exemplary configurations of the document 100, carrier 110, and card 120. At 200 is a bottom view of the document 100 without the carrier 110 or card 120, similar to the drawing shown in FIG. 1. At 210 is a bottom view of the document 100 affixed to carrier 110. The carrier 110 is at least slightly larger than the first cavity 105 and overlaps the document interior border 102 such that the carrier exterior border 111 is outside (relative to the bottom view) of the document interior border 102, while the carrier interior border 112 is inside (relative to the bottom view) of the document interior border 102 and defines an area at least slightly smaller than the first cavity 105. (In FIG. 2 at 210, document interior border 102 is shown in broken line for illustrative purpose, but is not visible from the bottom view of the form because it is covered by carrier 110). The document 100 and carrier 110 are permanently affixed with adhesive 135 or glue (shown in FIG. 3). At 220 and 230 is a bottom view and top view, respectively; of the assembled form including document 100 with carrier 110 and card 120, and FIG. 3 is a drawing of a cross section of the fully assembled form shown at 220 and 230. The card 120 and carrier 110 partially overlap such that the exterior border of the card 121 is substantially outside of the carrier interior border 112. The card 120 and carrier 110 are affixed with adhesive 140 or glue. The adhesive 140 affixing the card 120 and carrier 110 can be permanent, in which case the lines of weakness 125 are within the carrier interior border 112. Alternatively, the adhesive 140 affixing the card 120 and carrier 110 can be temporary adhesive (e.g., for a lift removal). In this manner, the first cavity 105 and second cavity 115 are aligned to allow access to the bottom of the card 120 from the bottom of the form.

In some embodiments, by breaking, tearing, or otherwise utilizing the lines of weakness 125 (e.g., punching out), a final card can be removed from the card 120. Additionally, multiple cards 120 can fit in a single first cavity 105, and/or the document 100 can contain multiple first cavities 105 each with one or more respective cards.

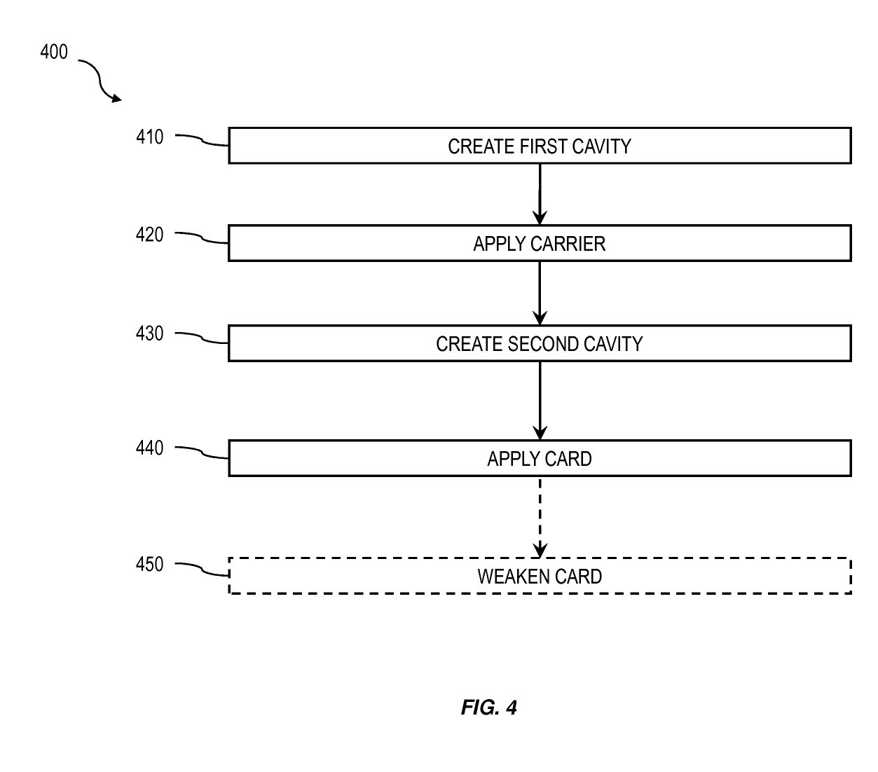

FIG. 4 is a process flow diagram 400 for assembly of the form. At 410 the first cavity can be created 105 by punching or die-cutting the document 105. At 420, the carrier 110 can be applied to the document 105. At 430, the second cavity 115 can be created by punching or die cutting the carrier 110. At 440, card 120 can be applied to the carrier 110. Optionally, at 450, the card 120 can be weakened to create the lines of weakness 125. These steps do not require the particular order given in the example, or need be performed in a sequential order, to achieve desirable results. For example, the punching or die cutting of each component can be performed together, and then the applying, or vice versa.

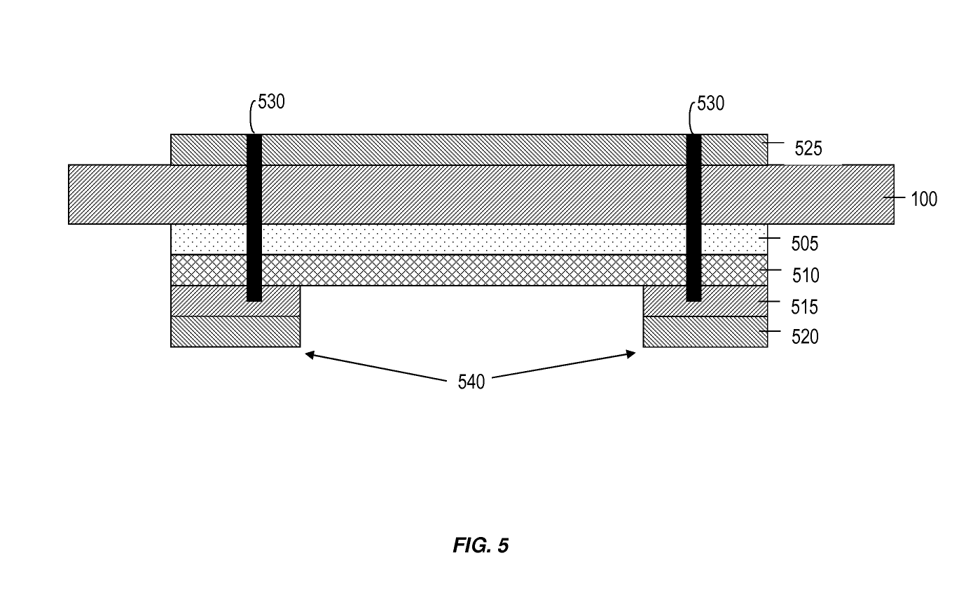

FIG. 5 is a diagram illustrating a cross section of an embodiment of a lift laminate form with cavity. The lift laminate form shown in FIG. 5 includes a portion of the document 100, an adhesive layer 505, a laminate 510, a temporary adhesive layer 515, and a film layer 520. Optionally, the form can include a second permanent laminate layer 525. A cut through the film layer 520 and temporary adhesive layer 515 can define an interior border 540 thereby forming a cavity through the film layer 520 and temporary adhesive layer 515 to expose the laminate layer 510 for the reception of print. The form includes a kiss cut at 530 that penetrates at least to the temporary adhesive layer 515. The kiss cut 530 defines a card area that is greater in dimension than the area defined by the interior border 540 of the film layer 520 and temporary adhesive layer 515. The configuration shown in FIG. 5 allows the card to be removed via lifting leaving behind the film layer 520 and area of the remaining layers defined outside of the kiss cut. The cavity defined by the film layer 520 and temporary adhesive layer 515 interior border 540 can be formed prior to application of the film layer 520 and adhesive layer 515 to the form or after the application (using e.g., a kiss cut technique).

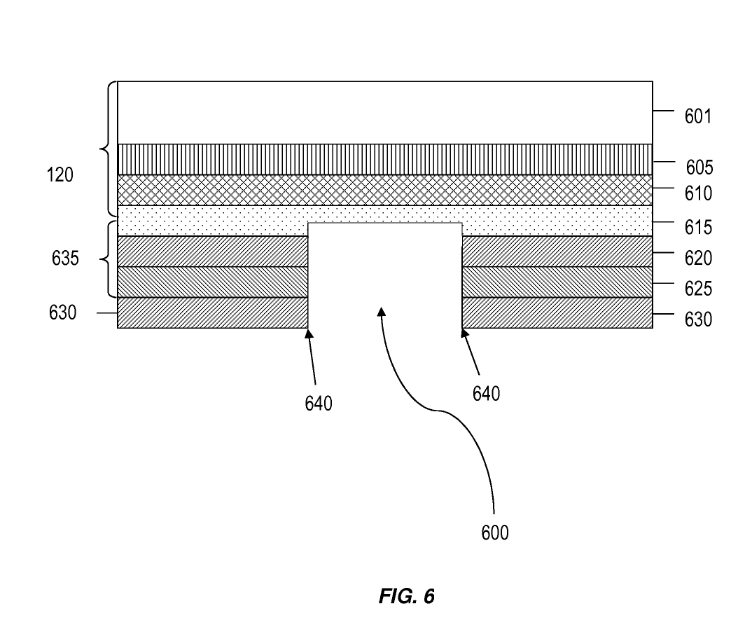

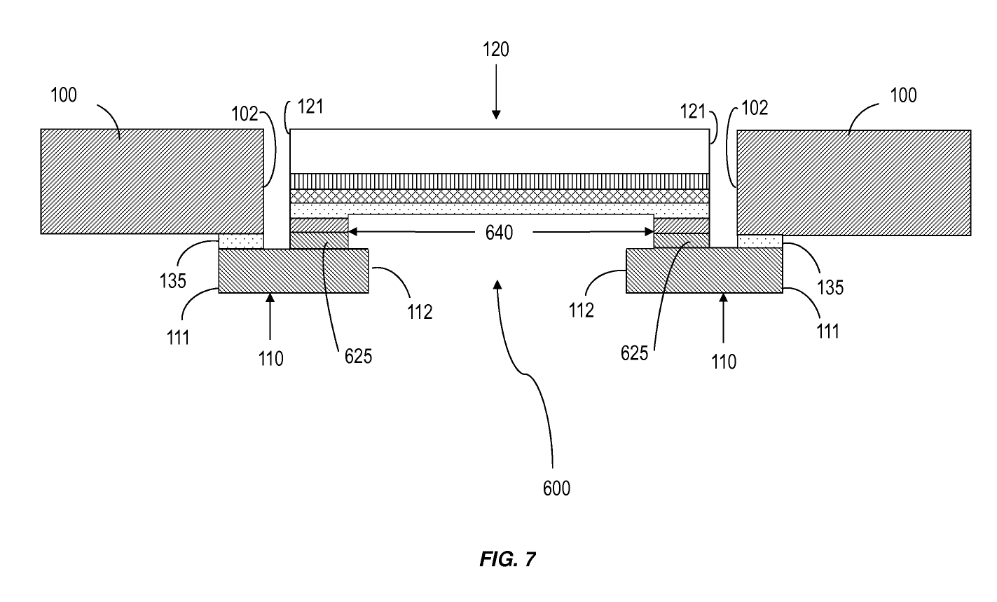

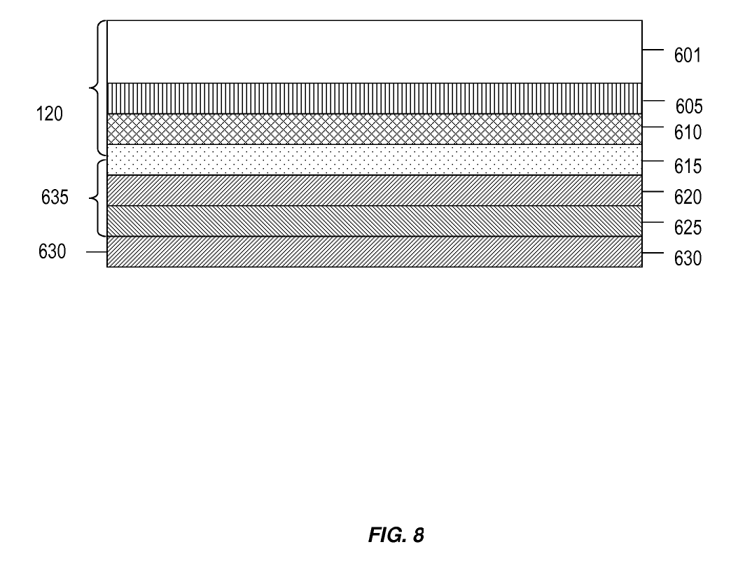

FIG. 6 is a diagram illustrating an embodiment of a lift card 120 with additional material 635 and FIG. 7 is a diagram of the assembled lift form including the document 100, carrier 110, and card 120. In this example, the card 120 has additional material 635 that includes a cavity 600. The card material includes a top layer card 601, such as paper or a variety of plastic, an adhesive layer 605, a film layer 610 that can comprise a plastic, a separation material 615, a film level 620, a second adhesive layer 625 and a throwaway liner 630. Separation material 615 layers can include a range of material such as breakaway coating, dry peel coating, coupon adhesive, EZ release (any of which are available from Stratatac, Saint Charles, Ill.) or other material with similar characteristics. The removable card typical includes the top layer card 601, adhesive layer 605, film layer 610, and at least a portion of the separation material 615. The cavity 600 can be created by a kiss-cut of the separation material 615, film 620, adhesive 625, and throwaway liner 630. The kiss cut defines a card interior border 640. The cavity can be created prior to, or after, application to a carrier 110. FIG. 8 is a diagram illustrating a cross section view of an example embodiment of a lift card 120 with additional material 635 that has not been kiss-cut prior to application to a carrier 110.

FIG. 7 illustrates an example card 120 with associated material 635, document 100, and carrier 110. Throwaway liner 630 can be removed prior to application of the card 120 and additional material 635 to the carrier 110. In this embodiment, the additional material cavity 600 interior border 640 is between the carrier interior border 112 and the card exterior border 121. That is, the card material cavity 600 is wider than the carrier cavity 115 (equivalently, the carrier cavity 115 is narrower than the card material cavity 600). The form in FIG. 7 allows imaging of the card 120 on both sides and removal of the card from the form by lifting. When a card 120 is removed, additional material 635 remains attached to carrier 110.

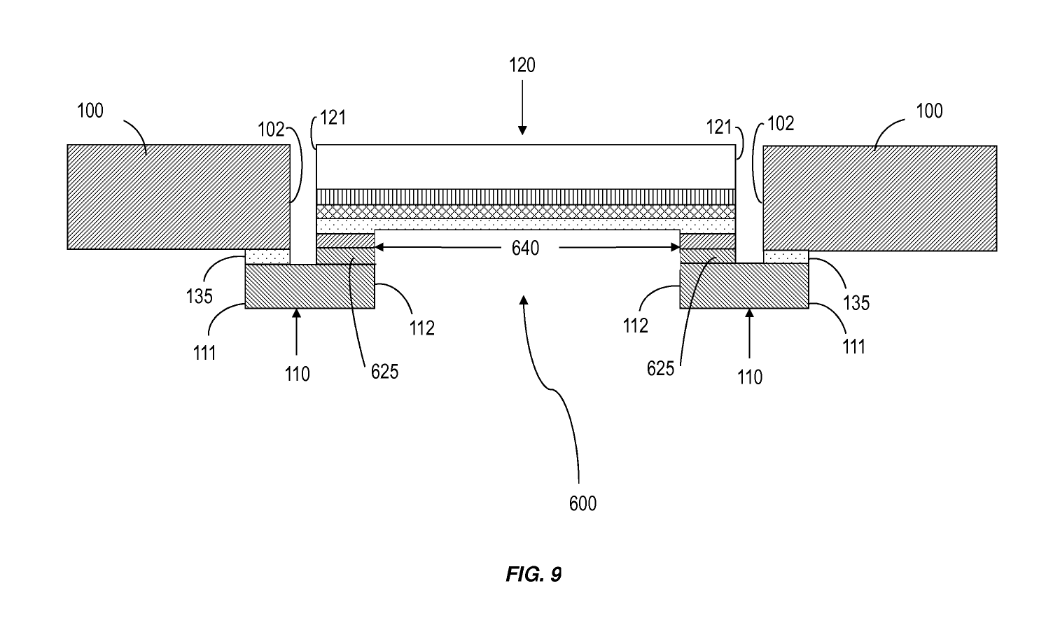

FIG. 9 is a diagram illustrating a cross section view of another example embodiment of an assembled lift form including the document 100, carrier 110, and card 120. In this example, the additional material cavity 600 interior border 640 is aligned with the carrier interior border 112. The form of FIG. 9 can be produced by, for example, applying a lift card 120 with additional material 635 to a carrier 110. The additional material 635 and carrier 110 are not pre kiss cut as described above. Then, both the carrier 110 and additional material 635 can be kiss cut to form the second cavity 115 and additional material cavity 640. The form in FIG. 9 allows the card 120 to be imaged on both sides and removed from the form by lifting.

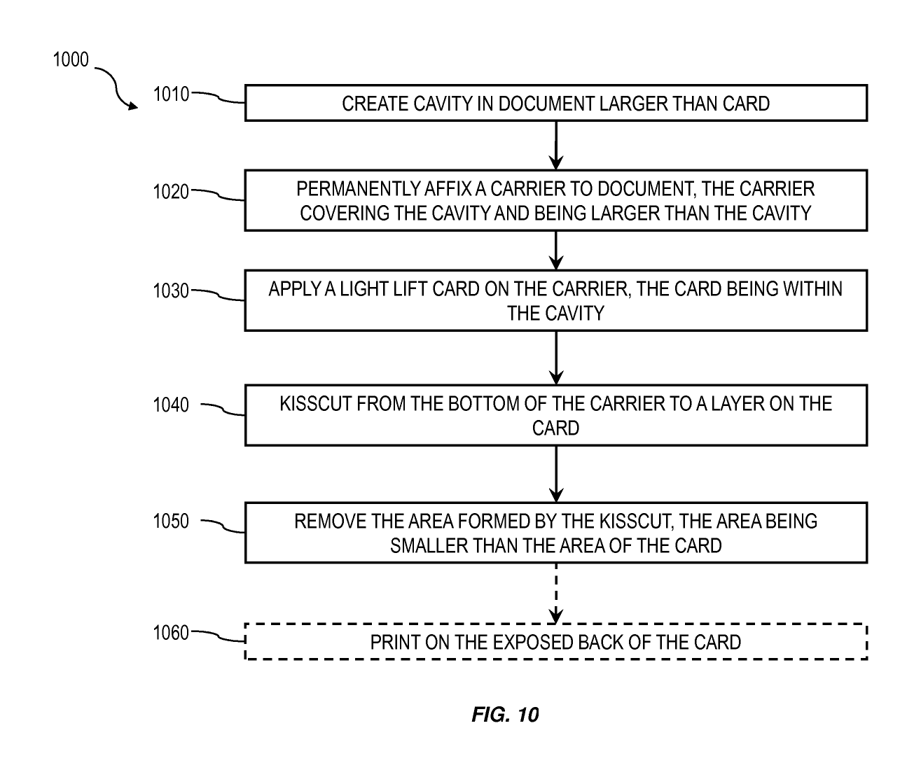

FIG. 10 is a process flow diagram 1000 illustrating an example method of producing a form that enables imaging on both sides of a card. At 1000, a cavity is created in a document. The cavity is larger than the card. At 1020, a carrier is permanently affixed to the document such that the carrier covers the cavity and is larger than the cavity. At 1030, a lift card is applied to the carrier, the card being within the cavity. The lift card can include a coupon style card. At 1040, the carrier and affixed card is kiss cut from the bottom of the carrier through the carrier to a depth/layer of the card, the kiss cut defining an area. For example, the cut depth can be to a card laminate layer or into a coupon film material. At 1050, an area defined by the kiss cut is removed forming a cavity. The area defined by the kiss cut is smaller than the size of the card. Optionally, at 1060, the back of the card can be printed on. Additionally, the form is in a condition to allow removal of the card via lifting off the face of the card.

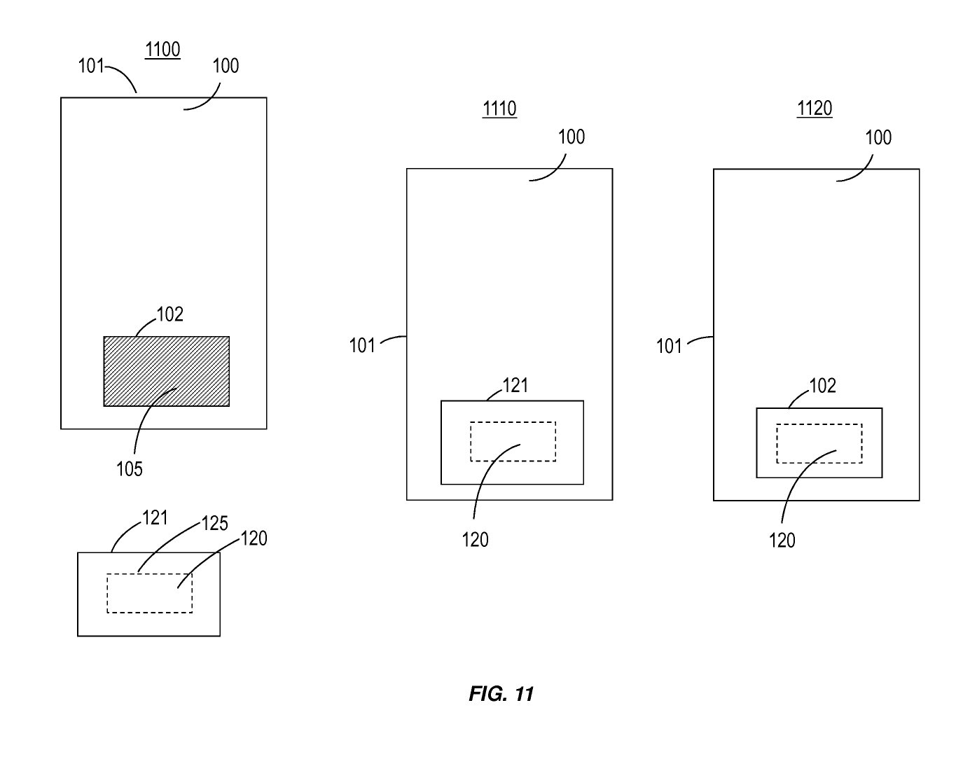

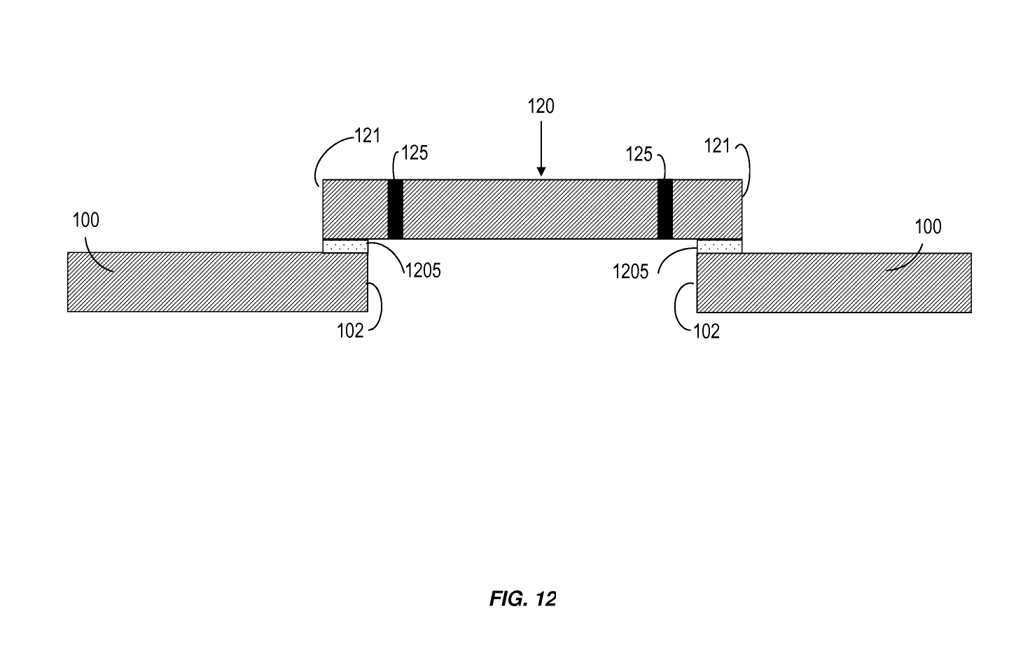

FIG. 11 is a series of drawings illustrating another exemplary configuration of components of the current subject matter. At 1100 is a view of the individual components, specifically, a document 100 and a card 120 (as may be shown, e.g., before they are affixed together). The document 100 includes a first cavity 105 defined by an interior border 102. The card 120 includes an exterior border 121 and lines of weakness 125 that define an area. At 1110 is a top view of the document 100 affixed to card 120. The card 120 is affixed via permanent adhesive or glue 1205 (shown in FIG. 12). The card 120 overlaps the document interior border 102 such that the card exterior border 121 is outside the document interior border 102 (relative to the top view) while the lines of weakness 125 is inside (relative to the top view) of the document interior border 102. At 1120 is a bottom view of the assembled example form including document 100 with card 120. A portion of the card 120, including the entire area defined by the lines of weakness 125 is visible through the first cavity 105 defined by the interior border 102. FIG. 12 is a drawing of a cross section of the fully assembled form shown at 1110 and 1120. The document 100 is on a first plane and the card 120 is on a second plane. The first cavity 105 and the card 120 are aligned to allow access to the bottom of the card 120 from the bottom of the form. The card 120 can be printed on both the top and bottom sides of the card 120 and the lines of weakness 125 can be torn, broken, or punched out, to remove a final card.

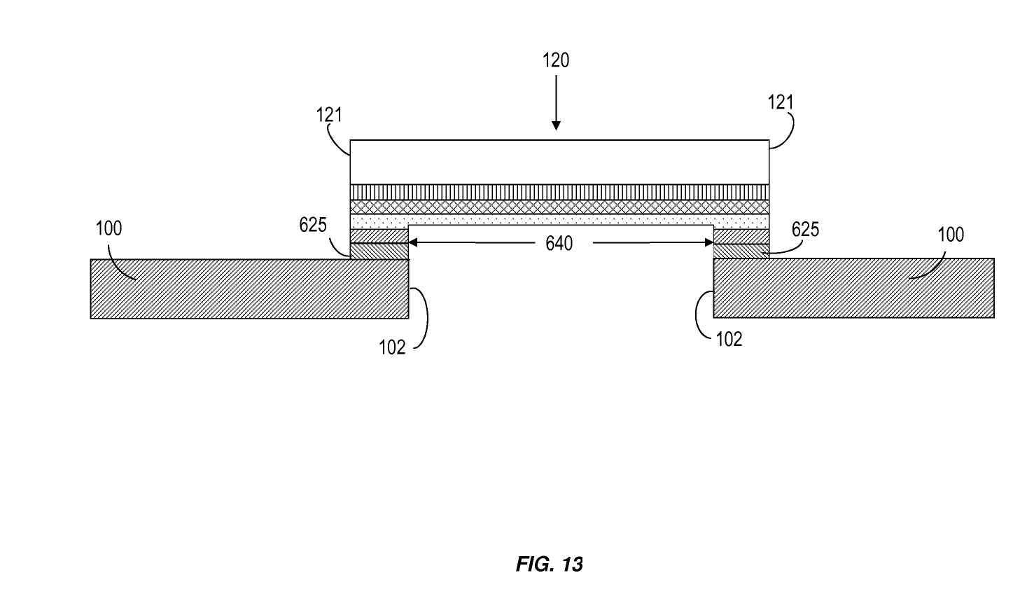

FIG. 13 is a drawing of a cross section of another example fully assembled form of an alternate embodiment of the form shown in FIG. 12 using a card 120 as illustrated in FIG. 6. In this embodiment, the card 120 including additional material 635 and card cavity 600 is applied directly to the document 100 over the first cavity. The first cavity 105 and the card cavity 600 are aligned to allow access to the bottom of the card 120 from the bottom of the form. The first cavity 105 and card cavity 600 can be of the same or different dimension or area. The card 120 can be printed on both the top and bottom sides of the card 120 and the final card can be removed via a lift technique thereby leaving the additional material 635 affixed to the document.

The current subject matter can include many variations, for example, the current subject matter can be implemented using cut sheet, fan fold, or rolls. The current subject matter can include a traditional document, a pressure seal mailer using cohesive to seal, a water seal form, a self-mailer for tabbing, or in a folded mailer where glue is applied on the folder. The pressure seal may be of any construction including but not limited to Z, C, V, eccentric Z, eccentric C, double parallel, eccentric double parallel, 1 part 2 way, 2 part 2 way, etc. Printing can occur via inkjet, laser, or any other imaging process. The current subject matter can be used independently or combined with other documents.

Although a few variations have been described in detail above, other modifications are possible. For example, the logic flows depicted in the accompanying figures and described herein do not require the particular order shown, or sequential order, to achieve desirable results. Additionally, layers of material such as laminates, adhesives, and films may be added, removed, or substituted to the subject matter described herein. Other embodiments may be within the scope of the following claims.

What is claimed is:

1. A form with information card comprising:
a planar document with a top and bottom surface and a continuous interior border defining a first cavity through the top and bottom surfaces;
a planar carrier with a top and bottom surface, an area at least slightly larger than the first cavity and a continuous interior border defining a second cavity through the top and bottom surfaces, the carrier permanently affixed to the bottom surface of the document, overlapping the document first cavity, and at least smaller than the document in dimension; and
a planar card with a top and bottom surface affixed to the carrier, overlapping the second cavity, residing within the first cavity, and coplanar with the document sheet such that a portion of the bottom surface of the card is exposed to receive print through the second cavity from a printer while the card resides in the form.

2. The form of claim 1, wherein the card is permanently affixed to the carrier and the card further includes one or more lines of weakness defining an area.

3. The form of claim 1, wherein the card is temporarily affixed to the carrier and removable via lifting.

4. The form of claim 1, wherein the card further includes additional material and a card cavity in the additional material, the additional material being permanently affixed to the carrier and a final card temporarily affixed to the additional material such that the final card can remove from the additional material via lifting.

5. A form with information card comprising:
a planar document with a top and bottom surface and a continuous interior border defining a first cavity through the top and bottom surfaces;
a planar card with a top and bottom surface affixed to the top surface of the document, and overlapping the first cavity such that a portion of the bottom surface of the card is exposed to receive print through the first cavity from a printer while the card resides on the form.

6. The form of claim 5, wherein the card is permanently affixed to the document and the card further includes one or more lines of weakness defining an area.

7. The form of claim 5, wherein the card is temporarily affixed to the document and removable via lifting.

8. The form of claim 7, wherein the card further includes additional material and a card cavity in the additional material, the additional material being permanently affixed to the document and a final card temporarily affixed to the additional material such that the final card can remove from the additional material via lifting.

9. A form with information card comprising:
a planar document with a top and bottom surface;
one or more laminate layers permanently adhered to the document;
a film layer temporarily adhered with adhesive to one of the laminate layers, the film layer and adhesive having a cavity; and
a substantially continuous cut through at least the document and one or more laminate layers defining a card area, wherein the film layer and adhesive cavity defines an area of dimension less than the area defined by the continuous cut.
